(19) United States
(12) Patent Application Publication
(10) Pub. No.: US 2026/0013522 A1
(43) Pub. Date: Jan. 15, 2026

(54) FATS AND OILS COMPOSITION FOR CHOCOLATE AND CHOCOLATE

(71) Applicant: THE NISSHIN OILLIO GROUP, LTD., Tokyo (JP)

(72) Inventors: Wakako KANAMARU, Yokohama-shi, Kanagawa (JP); Akira AKAHANE, Yokohama-shi, Kanagawa (JP); Madoka KASHIWAKURA, Yokohama-shi, Kanagawa (JP)

(21) Appl. No.: 18/994,711

(22) PCT Filed: Jul. 13, 2023
(86) PCT No.: PCT/JP2023/025893

§ 371 Date: Jan. 15, 2025

(30) Foreign Application Priority Data
Aug. 5, 2022 (JP) 2022-125911

(51) Int. Cl. A23D 9/00; A23G 1/36

(52) U.S. Cl. CPC A23D 9/00; A23G 1/36

(57) ABSTRACT

An object of the present invention is to provide chocolate having good solidification properties and melting mouthfeel and hardly causing blooming, and a fats and oils composition for chocolate for producing the chocolate. The present invention is a fats and oils composition for chocolate satisfying conditions (a) to (e) below: (a) 25 to 55 mass % of a saturated fatty acid having 14 or less carbons is contained as a constituent fatty acid; (b) 30 to 60 mass % of a saturated fatty acid having 16 to 18 carbons is contained as a constituent fatty acid; (c) 5 to 30 mass % of an unsaturated fatty acid is contained as a constituent fatty acid; (d) the mass ratio of the content of a saturated fatty acid to the content of an unsaturated fatty acid in constituent fatty acids is 4.0 to 7.0; and (e) 50 to 75 mass % of a triglyceride in which the total number of carbons of constituent fatty acid residues is 40 to 48 is contained.

### TECHNICAL FIELD

The present invention relates to chocolate and a fats and oils composition for chocolate for producing the chocolate.

### BACKGROUND ART

Chocolate is a confection having fats and oils as the skeleton, and cocoa butter derived from cacao beans is usually used as the fats and oils. Since cocoa butter is expensive, a cocoa butter substitute produced from vegetable fats and oils is often used as the fats and oils for producing chocolate. The cocoa butter substitute is also called hard butter, and the hard butter is usually classified into tempering type hard butter and non-tempering type hard butter.

Since the tempering type hard butter is made of fats and oils containing a large amount of a symmetrical triglyceride (triacylglycerol) similar to cocoa butter, the chemical composition and physical properties of the tempering type hard butter are similar to those of the core butter. Therefore, the tempering type hard butter has good compatibility with the cocoa butter, and can be freely blended with the cocoa butter. However, similarly to the cocoa butter, the tempering type hard butter requires a tempering operation at the time of producing chocolate.

On the other hand, the non-tempering type hard butter is made of fats and oils having a chemical composition completely different from that of the cocoa butter but having melting behavior similar to that of the cocoa butter. The non-tempering type hard butter is inexpensive compared to the cocoa butter, does not require complicated tempering work during chocolate production, and has good workability. Therefore, the non-tempering type hard butter is widely used as the fats and oils for chocolate. The non-tempering type hard butter is classified into lauric acid type hard butter and non-lauric acid type hard butter depending on the raw material fats and oils.

As the non-lauric acid type hard butter, a partially hydrogenated oil of liquid oil such as palm olein or soybean oil, or a high fraction or a mid fraction obtained by fractionating the partially hydrogenated oil is used. Since the non-lauric acid type hard butter has better compatibility with the cocoa butter than the lauric acid type hard butter, a larger amount of the cocoa butter can be blended to the non-lauric acid type hard butter than to the lauric acid type hard butter. However, the melting property of the non-lauric acid type hard butter is slightly less sharp than that of the lauric acid type hard butter, and thus chocolate using the non-lauric acid type hard butter may not have sharp melting mouthfeel.

In addition, the non-lauric acid type hard butter contains a large amount of a trans-fatty acid generated at the time of partial hydrogenation, and thus is also called a trans acid type hard butter. The use of the non-lauric acid type hard butter containing a large amount of a trans-fatty acid has been avoided since the adverse health effects of the trans-fatty acid have been recognized. Based on such a background, a non-lauric acid type hard butter having a reduced trans-fatty acid content is tinder development. However, the non-lauric acid type hard butter having a reduced trans-fatty acid content may be slow in solidification speed, and the chocolate using the non-lauric acid type hard butter having a reduced trans-fatty acid content may be problematic in terms of solidification properties.

As the lauric acid type hard butter, processed fats and oils of lauric fats and oils such as a fully hydrogenated oil of palm kernel stearin are used. Since the lauric acid type hard butter has an extremely sharp melting property, chocolate using the lauric acid type hard butter has sharp melting mouthfeel. As the chocolate using the lauric acid type hard butter, chocolates of Patent Literatures 1 to 6 and the like have been proposed.

On the other hand, the lauric acid type hard butter has extremely poor compatibility with the cocoa butter, so that the amount of cacao mass containing the cocoa butter needs to be reduced as much as possible in the chocolate using the lauric acid type hard butter, and the cacao flavor is poor. Further, the chocolate using the lauric acid type hard butter has extremely poor compatibility with the cocoa butter, and therefore has a problem that blooming is likely to occur.

In order to improve the compatibility of the lauric acid type hard butter with the cocoa butter, interesterified fats and oils of lauric fats and oils and non-lauric fats and oils have been developed as a new lauric acid type hard butter. Although chocolate using the interesterified fats and oils of lauric fats and oils and non-lauric fats and oils has improved compatibility with the cocoa butter and less likely to cause blooming, the melting mouthfeel, which is a characteristic of the lauric acid type hard butter, deteriorates, and the solidification speed is slow, which may cause a problem in terms of solidification properties.

From the above-described background, there has been a demand for the development of a fats and oils composition for chocolate capable of providing chocolate which has good melting mouthfeel and solidification properties and hardly causes blooming.

### CITATION LIST

### Patent Literature

Patent Literature 1: JP-A-10-108624
Patent Literature 2: JP-A-11-318339
Patent Literature 3: JP-A-2000-226598
Patent Literature 4: JP-A-2003-299442
Patent Literature 5: JP-A-2008-271885
Patent Literature 6: JP-A-2009-17821

### SUMMARY OF INVENT ION

### Problems to be Solved by Invention

An object of the present invention is to provide chocolate having good melting mouthfeel and solidification properties and hardly causing blooming, and a fats and oils composition for chocolate for producing the chocolate.

### Melting Mouthfeel

### Solution to Problems

The present inventors have intensively studied to solve the above-described problems. As a result, it has been found that the present problem can be solved by containing specific amounts of a specific triglyceride and a specific fatty acid in a fats and oils composition. Thus, the present invention has been completed.

That is, a first invention of the present invention is a fats and oils composition for chocolate satisfying conditions (a) to (e) below:
(a) 25 to 55 mass % of a saturated fatty acid having 14 or less carbons is contained as a constituent fatty acid;
(b) 30 to 60 mass % of a saturated fatty acid having 16 to 18 carbons is contained as a constituent fatty acid;
(c) 5 to 30 mass % of an unsaturated fatty acid is contained as a constituent fatty acid;
(d) the mass ratio of the content of a saturated fatty acid to the content of an unsaturated fatty acid in constituent fatty acids is 4.0 to 7.0; and
(e) 50 to 75 mass % of a triglyceride in which the total number of carbons of constituent fatty acid residues is 40 to 48 is contained.

A second invention of the present invention is the fats and oils composition for chocolate according to the first invention, which satisfies condition (f) below:
(f) the mass ratio of the content of palmitic acid to the content of stearic acid in constituent fatty acids is 1.5 to 2.2.

A third invention of the present invention is chocolate containing the fats and oils composition for chocolate according to the first invention or the second invention.

A fourth invention of the present invention is the chocolate according to the third invention, in which 70 mass % or more of the fats and oils composition for chocolate is contained in fats and oils contained in the chocolate.

### Effects of Invention

According to the present invention, it is possible to provide chocolate which has good melting mouthfeel and solidification properties and hardly causes blooming, and a fats and oils composition for chocolate for producing the chocolate.

### Melting Mouthfeel

### DESCRIPTION OF EMBODIMENTS

A fats and oils composition for chocolate according to an embodiment of the present invention is a fats and oils composition satisfying conditions (a) to (e) below:
(a) 25 to 55 mass % of a saturated fatty acid having 14 or less carbons is contained as a constituent fatty acid;
(b) 30 to 60 mass % of a saturated fatty acid having 16 to 18 carbons is contained as a constituent fatty acid;
(c) 5 to 30 mass % of an unsaturated fatty acid is contained as a constituent fatty acid;
(d) the mass ratio of the content of a saturated fatty acid to the content of an unsaturated fatty acid in constituent fatty acids is 4.0 to 7.0; and
(e) 50 to 75 mass % of a triglyceride in which the total number of carbons of constituent fatty acid residues is 40 to 48 is contained.

In the present invention, the chocolate is not limited by “Fair Competition Code Regarding Chocolate Labeling” (National Chocolate Industry Fair Trade Commission) or legal regulations, and refers to a food which is produced by using fats and oils and saccharinity as main raw materials and adding a cacao component (cacao mass, cocoa powder or the like), a dairy product, a flavor, an emulsifier, and the like as necessary through chocolate production process (all or part of a mixing process, a refining process, a conching process, a temperature control process, a molding process, a cooling process, and the like), and in which the fats and oils form a continuous phase without substantially containing water (the moisture content is preferably 3 mass % or less, more preferably 2 mass % or less, and still more preferably 1 mass % or less). In the present invention, the chocolate may be any of dark chocolate, milk chocolate, white chocolate, and color chocolate.

The fats and oils composition for chocolate according to an embodiment of the present invention includes 25 to 55 mass %, preferably 27 to 53 mass %, and more preferably 30 to 50 mass % of a saturated fatty acid having 14 or less carbons as a constituent fatty acid (condition (a)). Hereinafter, a saturated fatty acid having 14 or less carbons may be referred to as a C14 or less SFA.

The fats and oils composition for chocolate according to an embodiment of the present invention includes 30 to 60 mass %, preferably 32 to 58 mass %, and more preferably 35 to 55 mass % of a saturated fatty acid having 16 to 18 carbons as a constituent fatty acid (condition (b)). Hereinafter, a saturated fatty acid having 16 to 18 carbons may be referred to as a (C16 to 18 SFA.

The fats and oils composition for chocolate according to an embodiment of the present invention includes 5 to 30 mass %, preferably 7 to 27 mass %, and more preferably 10 to 23 mass % of an unsaturated fatty acid as a constituent fatty acid (condition (c)). Hereinafter, an unsaturated fatty acid may be referred to as a USFA.

In the fats and oils composition for chocolate according to an embodiment of the present invention, the mass ratio of the content (mass %) of a saturated fatty acid to the content (mass %) of an unsaturated fatty acid in constituent fatty acids is preferably 4.0 to 7.0, more preferably 4.1 to 6.0, still more preferably 4.2 to 5.5, and most preferably 4.3 to 5.5 (condition (d)). Hereinafter, the mass ratio of the content of a saturated fatty acid to the content of an unsaturated fatty acid may be referred to as an SFA/USFA.

The fats and oils composition for chocolate according to an embodiment of the present invention includes 50 to 75 mass %, preferably 52 to 70 mass %, and more preferably 55 to 65 mass % of a triglyceride in which the total number of carbons of constituent fatty acid residues is 40 to 48 (condition (e)). Hereinafter, a triglyceride in which the total number of carbons of constituent fatty acid residues is 40 to 48 may be referred to as a (40 to 48 TG.

When the fats and oils composition for chocolate according to an embodiment of the present invention satisfies the above-described conditions (a) to (e), chocolate having good melting mouthfeel and solidification properties and hardly causing blooming is obtained.

In the fats and oils composition for chocolate according to an embodiment of the present invention, the mass ratio of the content (mass %) of palmitic acid to the content (mass %) of stearic acid in constituent fatty acids is preferably 1.5 to 2.2, more preferably 1.6 to 2.1, and still more preferably 1.7 to 2.1 (condition (f)). Hereinafter, the mass ratio of the content of palmitic acid to the content of stearic acid may be referred to as a P/St. Stearic acid may be referred to as St, and palmitic acid may be referred to as P.

The fats and oils composition for chocolate according to an embodiment of the present invention includes preferably 10 mass % or less, more preferably 8 mass % or less, and still more preferably 5 mass % or less of a saturated fatty acid having 10 or less carbons as a constituent fatty acid. Hereinafter, a saturated fatty acid having 10 or less carbons may be referred to as a C10 or less SFA.

In the fats and oils composition for chocolate according to an embodiment of the present invention, the mass ratio of the content (mass %) of lauric acid to the content (mass %) of stearic acid in constituent fatty acids is preferably 1.0 to 3.0, more preferably 1.2 to 2.7, and still more preferably 1.2 to 2.5. Hereinafter, the mass ratio of the content of lauric acid to the content of stearic acid in constituent fatty acids may be referred to as an La/St. Lauric acid may be referred to as La.

The fats and oils composition for chocolate according to an embodiment of the present invention includes preferably 5 mass % or less, more preferably 3 mass % or less, and still more preferably 1 mass % or less of a saturated fatty acid having 20 to 22 carbons as a constituent fatty acid. Hereinafter, a saturated fatty acid having 20 to 22 carbons may be referred to as a C20 to 22 SFA.

The fats and oils composition for chocolate according to an embodiment of the present invention includes preferably 70 to 95 mass %, more preferably 73 to 93 mnass %, and still more preferably 76 to 90 mass % of a saturated fatty acid as a constituent fatty acid.

The fats and oils composition for chocolate according to an embodiment of the present invention includes preferably 5 mass % or less, more preferably 3 mass % or less, and still more preferably 1 mass % or less of a trans-fatty acid as a constituent fatty acid. Hereinafter, a trans-fatty acid may be referred to as a TFA.

The fats and oils composition for chocolate according to an embodiment of the present invention includes preferably 5 to 23 mass %, more preferably 9 to 22 mass %, and still more preferably 11 to 22 mass % of a triglyceride in which the total number of carbons of constituent fatty acid residues is 34 to 38. Hereinafter, a triglyceride in which the total number of carbons of constituent fatty acid residues is 34 to 38 may be referred to as a C34 to 38 TG.

The fats and oils composition for chocolate according to an embodiment of the present invention includes preferably less than 1 mass %, more preferably less than 0.5 mass %, and still more preferably less than 0.05 mass % of a triglyceride in which the total number of carbons of constituent fatty acid residues is 58 or more. Hereinafter, a triglyceride in which the total number of carbons of constituent fatty acid residues is 58 or more may be referred to as a C58 or more TG.

The production of the fats and oils composition for chocolate according to an embodiment of the present invention is not particularly limited as long as the chemical composition of a triglyceride, the chemical composition of a fatty acid, and the like are within the above-described ranges, and fats and oils usually used for the production of chocolate can be used. Specific examples of the fats and oils include cocoa butter, palm kernel oil, coconut oil, palm oil, palm fractionated oil (palm mid fraction, palm stearin, palm olein and the like), shea fat, sal fat, illipe fat, soybean oil, rapeseed oil, cottonseed oil, safflower oil, sunflower oil, rice oil, corn oil, sesame oil, olive oil, and milk fat, and processed fats and oils thereof (fats and oils subjected to one or more treatments among mixing, fractionation, hydrogenation, and interesterification). Two or more kinds of the fats and oils may be used in combination.

In the production of the fats and oils composition for chocolate according to an embodiment of the present invention, random interesterified fats and oils of lauric fats and oils having an iodine value of 15 to 35, random interesterified fats and oils of lauric fats and oils having an iodine value of 10 or less, and non-interesterified lauric fats and oils are preferably used.

In the present invention, the random interesterified fats and oils of lauric fats and oils refer to fats and oils obtained by performing a random interesterification reaction and containing lauric fats and oils as raw material fats and oils to be subjected to a random interesterification reaction. In the present invention, the lauric fats and oils refer to fats and oils in which the content of lauric acid in fatty acids constituting fats and oils is 30 mass % or more. In the present invention, the non-interesterified lauric fats and oils refer to lauric fats and oils not subjected to an interesterification reaction. Hereinafter, the random interesterified fats and oils of lauric fats and oils having an iodine value of 15 to 35 are referred to as fats and oils A, the random interesterified fats and oils of lauric fats and oils having an iodine value of 10 or less are referred to as fats and oils B, and the non-interesterified lauric fats and oils are referred to as fats and oils C.

The fats and oils composition for chocolate according to an embodiment of the present invention preferably includes 65 to 97 mass % of fats and oils A, 0 to 37 mass % of fats and oils B, and 0 to 30 mass % of fats and oils C, more preferably includes 70 to 95 mass % of fats and oils A, 0 to 30 mass % of fats and oils B, and 0 to 25 mass % of fats and oils C, and further preferably includes 75 to 92 mass % of fats and oils A, 0 to 25 mass % of fats and oils B, and 0 to 20 mass % of fats and oils C.

The fats and oils A used in the production of the fats and oils composition for chocolate according to an embodiment of the present invention are preferably random interesterified fats and oils of lauric fats and oils and non-lauric fats and oils.

In the present invention, the non-lauric fats and oils are fats and oils other than the lauric fats and oils.

Specific examples of the lauric fats and oils include coconut oil, palm kernel oil, and fractionated oils, interesterified fats and oils, and hydrogenated oils thereof. In the present invention, the lauric fats and oils can be used singly or in combination of two or more kinds thereof.

The lauric fats and oils used for the production of the fats and oils A are preferably a fully hydrogenated oil of palm kernel oil.

The non-lauric fats and oils used for the production of the fats and oils A are preferably palm-based fats and oils.

In the present invention, the palm-based fats and oils refer to palm oil and processed fats and oils of palm oil such as palm fractionated oil. In the present invention, the processed fats and oils of palm fractionated oil such as interesterified oil of palm fractionated oil are also palm-based fats and oils.

Specific examples of the palm-based fats and oils include palm oil, palm olein, interesterified fats and oils of palm olein, palm stearin, and a palm mid fraction (PMF). In the present invention, the palm-based fats and oils can be used singly or in combination of two or more kinds thereof.

The palm-based fats and oils used in the production of the fats and oils A are preferably palm-based fats and oils having an iodine value of 25 to 60, and more preferably palm stearin having an iodine value of 27 to 37 and a palm mid fraction having an iodine value of 40 to 50.

The fats and oils A used in the production of the fats and oils composition for chocolate according to an embodiment of the present invention have an iodine value of 15 to 35, preferably 18 to 30, and more preferably 20 to 28.

The fats and oils A used in the production of the fats and oils composition for chocolate according to an embodiment of the present invention include preferably 15 mass % or more and less than 30 mass %, more preferably 17 mass % or more and less than 27 mass %, and still more preferably 18 mass % or more and less than 25 mass % of lauric acid as a constituent fatty acid.

The fats and oils A used in the production of the fats and oils composition for chocolate according to an embodiment of the present invention include preferably 20 mass % or more and less than 40 mass %, more preferably 25 mass % or more and less than 38 mass %, and still more preferably 27 mass % or more and less than 35 mass % of palmitic acid as a constituent fatty acid.

The fats and oils A used in the production of the fats and oils composition for chocolate according to an embodiment of the present invention include preferably 5 mass % or more and less than 25 mass %, more preferably 8 mass % or more and less than 20 mass %, and still more preferably 10 mass % or more and less than 17 mass % of stearic acid as a constituent fatty acid.

The mixing ratio (lauric fats and oils:non-lauric fats and oils) of the lauric fats and oils and the non-lauric fats and oils of the raw material fats and oils to be subjected to a random interesterification reaction in the fats and oils A used in the production of the fats and oils composition for chocolate according to an embodiment of the present invention is preferably 35:65 to 65:35 by mass, more preferably 40:60 to 60:40 by mass, and still more preferably 45:55 to 55:45 by mass.

The random interesterification method at the time of producing the fats and oils A is not particularly limited, and can be carried out by a known method.

When the fats and oils A are produced, hydrogenation may be performed before and after random interesterification as necessary. The hydrogenation method is not particularly limited, and can be carried out by a known method.

The fats and oils B used in the production of the fats and oils composition for chocolate according to an embodiment of the present invention are preferably random interesterified fats and oils of lauric fats and oils and non-lauric fats and oils.

The lauric fats and oils used in the production of the fats and oils B are preferably palm kernel olein or a fully hydrogenated oil of palm kernel olein.

The non-lauric fats and oils used in the production of the fats and oils B are preferably palm-based fats and oils.

The palm-based fats and oils used in the production of the fats and oils B are preferably palm-based fats and oils having an iodine value of 25 to 60, and more preferably palm stearin having an iodine value of 27 to 37.

The fats and oils B used in the production of the fats and oils composition for chocolate according to an embodiment of the present invention have an iodine value of 10 or less, preferably 5 or less, and more preferably 1 or less.

The fats and oils B used in the production of the fats and oils composition for chocolate according to an embodiment of the present invention include preferably 15 mass % or more and less than 30 mass %, more preferably 17 mass % or more and less than 27 mass %, and still more preferably 18 mass % or more and less than 25 mass % of lauric acid as a constituent fatty acid.

The fats and oils B used in the production of the fats and oils composition for chocolate according to an embodiment of the present invention include preferably 20 mass % or more and less than 40 mass %, more preferably 25 mass % or more and less than 38 mass %, and still more preferably 27 mass % or more and less than 35 mass % of palmitic acid as a constituent fatty acid.

The fats and oils B used in the production of the fats and oils composition for chocolate according to an embodiment of the present invention include preferably 25 mass % or more and less than 45 mass %, more preferably 30 mass % or more and less than 40 mass %, and still more preferably 32 mass % or more and less than 38 mass % of stearic acid as a constituent fatty acid.

The mixing ratio (lauric fats and oils:non-lauric fats and oils) of the lauric fats and oils and the non-lauric fats and oils of the raw material fats and oils to be subjected to a random interesterification reaction in the fats and oils B used in the production of the fats and oils composition for chocolate according to an embodiment of the present invention is preferably 35:65 to 65:35 by mass, more preferably 40:60 to 60:40 by mass, and still more preferably 45:55 to 55:45 by mass.

The random interesterification method at the time of producing the fats and oils B is not particularly limited, and can be carried out by a known method.

When the fats and oils B are produced, hydrogenation may be performed as necessary. The hydrogenation method is not particularly limited, and can be carried out by a known method.

Specific examples of the fats and oils C used in the production of the fats and oils composition for chocolate according to an embodiment of the present invention include coconut oil, palm kernel oil, and fractionated oils and hydrogenated oils thereof. The fats and oils C can be used singly or in combination of two or more kinds thereof.

The fats and oils C used in the production of the chocolate according to an embodiment of the present invention have a slip melting point of preferably 25 to 50° C., more preferably 30 to 45° C., and still more preferably 32 to 43° C.

The fats and oils C used in the production of the fats and oils composition for chocolate according to an embodiment of the present invention are preferably a fully hydrogenated oil of lauric fats and oils, more preferably a fully hydrogenated oil of palm kernel oil or a fully hydrogenated oil of palm kernel stearin.

The fats and oils composition for chocolate of an embodiment of the present invention has a solid fat content (hereinafter, referred to as an SFC) of preferably 60 to 90% at 10° C., 45 to 80% at 20° C., and 15 to 55% at 30° C., more preferably 65 to 85% at 10° C., 48 to 75% at 20° C., and 20 to 50% at 30° C., and further preferably 68 to 80% at 10° C., 50 to 70% at 20° C., and 25 to 48% at 30° C.

The fats and oils composition for chocolate according to an embodiment of the present invention is preferably non-tempering type hard butter, and more preferably non-tempering type lauric acid type hard butter.

The fatty acid content of fats and oils can be measured by gas chromatography in accordance with AOCS Celf-96.

The triglyceride content of fats and oils can be measured by gas chromatography in accordance with AOCS Ce5-86.

The iodine value of fats and oils can be measured in accordance with “2.3.4.1-1996 Iodine Value (Wijs-Cyclohexane method)” of “Standard methods for the analysis of fats, oils and related materials (edited by Japan Oil Chemists' Society)”.

The slip melting point of fats and oils can be measured in accordance with “2.2.4.2-1996 Melting Point (slip melting point)” of “Standard methods for the analysis of fats, oils and related materials (edited by Japan Oil Chemists' Society)”.

The SFC of fats and oils can be measured in accordance with 2.2.9-2003 Solid fat content (NMR method) of “Standard methods for the analysis of fats, oils and related materials (edited by Japan Oil Chemists' Society)”.

The chocolate according to an embodiment of the present invention includes the fats and oils composition for chocolate according to an embodiment of the present invention.

The chocolate according to an embodiment of the present invention includes 70 mass %0 or more, more preferably 75 mass % or more, and still more preferably 80 to 95 mass % of the fats and oils composition for chocolate according to an embodiment of the present invention in fats and oils contained in the chocolate.

In the present invention, fats and oils contained in the chocolate refer to all the fats and oils contained in the chocolate. For example, when chocolate contains cacao mass, whole milk powder, and fats and oils a, the fats and oils are a mixed oil of cocoa butter contained in the cacao mass, milk fat contained in the whole milk powder, and the fats and oils a. That is, fats and oils contained in the chocolate in the present invention contain fats and oils (cocoa butter, milk fat and the like) contained in oil-containing raw materials (cacao mass, cocoa powder, whole milk powder and the like) in addition to the fats and oils blended in the chocolate.

The chocolate according to an embodiment of the present invention preferably includes cocoa butter.

The chocolate according to an embodiment of the present invention includes preferably 20 mass % or less, more preferably 17 mass % or less, still more preferably 15 mass % or less, and most preferably 5 to 15 mass % of cocoa butter in fats and oils contained in the chocolate.

In the present invention, the cocoa butter also includes cocoa butter in cacao raw materials such as cacao mass and cocoa powder containing cocoa butter, in addition to cocoa butter blended in chocolate.

The chocolate according to an embodiment of the present invention includes preferably 25 to 60 mass %, more preferably 25 to 50 mass %, and still more preferably 28 to 45 mass % of fats and oils.

The chocolate according to an embodiment of the present invention preferably includes saccharinity. In the present invention, the saccharinity refers to one obtained by excluding dietary fiber from carbohydrate. Specific examples of the saccharinity include saccharides, sugar alcohol (maltitol, xylitol, erythritol, sorbitol, lactitol, mannitol, reduced starch syrup, and the like), starch, oligosaccharide, and dextrin. In the present invention, saccharides are monosaccharides and disaccharides (glucose, fructose, galactose, sugar (sucrose), lactose, maltose, and the like). In the present invention, the saccharinity is saccharinity itself, and does not include saccharinity contained in other raw materials (for example, powdered milk or the like).

The saccharinity used in the production of the chocolate according to an embodiment of the present invention is preferably saccharides, and more preferably sugar or lactose.

The chocolate according to an embodiment of the present invention includes preferably 20 to 60 mass %, more preferably 23 to 55 mass %, and still more preferably 25 to 50 mass % of saccharinity.

The chocolate according to an embodiment of the present invention preferably includes a cacao component. In the present invention, the cacao component is a cacao raw material containing a solid content other than fats and oils among cacao raw materials obtained from cacao beans. Specific examples of the cacao component include cacao mass and cocoa powder.

The cacao component used in the production of the chocolate according to an embodiment of the present invention is preferably cacao mass or cocoa powder.

The chocolate according to an embodiment of the present invention preferably includes 0 to 35 mass %, more preferably 5 to 30 mass %, and still more preferably 10 to 25 mass % of the cacao component.

The chocolate according to an embodiment of the present invention preferably includes powdered milk. Specific examples of the powdered milk include skimmed milk powder and whole milk powder. The powdered milk used in the production of the chocolate according to an embodiment of the present invention is preferably skimmed milk powder or whole milk powder.

The chocolate according to an embodiment of the present invention includes preferably 0 to 30 mass %, more preferably 0 to 25 mass %, and still more preferably 0 to 20 mass % of the powdered milk.

In the chocolate according to an embodiment of the present invention, raw materials generally blended in chocolate can be used in addition to the fats and oils, the saccharinity, the cacao component, and the powdered milk. Specifically, for example, emulsifiers (sucrose fatty acid ester, polyglycerol fatty acid ester, polyglycerol condensed ricinoleic acid ester, sorbitan fatty acid ester, lecithin, and the like), soybean flour, soybean protein, fruit processed products, vegetable processed products, various powders such as powdered green tea and coffee powder, gums, starches, antioxidants, colorants, and flavors can be used.

The chocolate according to an embodiment of the present invention can be produced by a known method of manufacturing chocolate. The chocolate according to an embodiment of the present invention can be produced, for example, by using fats and oils, a cacao component, saccharinity, a dairy product, an emulsifier, and the like as raw materials through a mixing process, a refining process, a conching process, a cooling process, and the like. The chocolate of an embodiment of the present invention is preferably produced through a refining process.

The chocolate according to an embodiment of the present invention is preferably a non-tempering type chocolate.

The chocolate according to an embodiment of the present invention can be used as a coated chocolate, a filling chocolate, a soft chocolate (chocolate cream), or the like.

The chocolate according to an embodiment of the present invention has good melting mouthfeel and solidification properties, and is less likely to cause blooming.

Since the chocolate of an embodiment of the present invention hardly causes blooming, a product using the chocolate of an embodiment of the present invention can be expected to have an extended best-before expiration date. Therefore, the chocolate of an embodiment of the present invention can also be expected to improve the food loss problem.

The composite food product according to an embodiment of the present invention is a composite food product including the chocolate according to an embodiment of the present invention and a food product. In the present invention, the food product is a food product other than chocolate.

Specific examples of the food product used for the production of the composite food product according to an embodiment of the present invention include breads such as bread, salt bread, bread rolls, fruit bread, butter rolls, French bread, rolls, pastries, sweet dough, muffins, brioche, focaccia bagels, croissants, and Danish pastries, confectionery such as doughnuts, Japanese sponge cake (Castella), waffles, boro (small, round cookies), Yatsuhashi, rice crackers, karinto (traditional deep-fried sweet made of wheat) snacks, sponge cakes, Swiss roll, pound cakes, Baumkuchen, fruitcakes, madeleines, stollens, chou, eclairs, mille-feuille, pie, tart, macaroons, biscuits, cookies, crackers, shortbreads, langue de chat, steamed bread, pretzels, wafers, potato chips, snacks, crepes, souffle, and hardtacks, and fruits such as bananas, apples, and strawberries.

The composite food product according to an embodiment of the present invention can be produced by combining chocolate and a food product by a known method. Examples of the method for combining the chocolate according to an embodiment of the present invention and a food product include coating, filling, rolling, sandwiching, attaching, and kneading.

### EXAMPLES

Next, the present invention will be described with reference to Examples, but the present invention is not limited to these Examples.

### [Method for Analyzing Fatty Acid of Fats and Oils]

The fatty acid content of fats and oils was measured by gas chromatography in accordance with AOCS Celf-96.

### [Method for Analyzing Triglyceride of Fats and Oils]

The triglyceride content of fats and oils was measured by gas chromatography in accordance with AOCS Ce5-86.

### [Method for Measuring Iodine Value of Fats and Oils]

The iodine value of fats and oils was measured in accordance with “2.3.4.1-1996 Iodine Value (Wijs-Cyclohexane method)” of “Standard methods for the analysis of fats, oils and related materials (edited by Japan Oil Chemists' Society)”.

### [Method for Measuring Slip Melting Point of Fats and Oils]

The slip melting point of fats and oils was measured in accordance with “2.2.4.2-1996 Melting Point (slip melting point)” of “Standard methods for the analysis of fats, oils and related materials (edited by Japan Oil Chemists' Society)”.

### [Method for Measuring SFC of Fats and Oils]

The SFC of fats and oils was measured in accordance with 2.2.9-2003 Solid fat content (NMR method) of “Standard methods for the analysis of fats, oils and related materials (edited by Japan Oil Chemists' Society)”.

### [Production of Fats and Oils A1]

Mixed were 15 parts by mass of palm stearin (iodine value: 32), 35 parts by mass of a palm mid fraction (iodine value: 45), and 50 parts by mass of a fully hydrogenated oil (lauric acid content: 48.4 mass %) of palm kernel. The obtained mixed oil was subjected to a random interesterification reaction to obtain fats and oils A1 (iodine value: 23, lauric acid content: 23.7 mass %, palmitic acid content: 30.4 mass %, stearic acid content: 13.4 mass %).

In the interesterification reaction, the raw material fats and oils were sufficiently dried according to a known method and added with sodium methoxide in an amount of 0.2 mass % with respect to the raw material fats and oils, and then the mixture was reacted under reduced pressure while stirring at 120° C. for 0.5 hour. The reaction was completed by adding a 50 mass % aqueous solution of citric acid for neutralization, and then the mixture was washed 3 times with an equal amount of hot water, dehydrated and dried, and decolorized and deodorized by a known method to obtain interesterified fats and oils.

### [Production of Fats and Oils B1 ]

Mixed were 50 parts by mass of palm kernel olein (lauric acid content: 41 mass %) and 50 parts by mass of palm stearin (iodine value: 32). The obtained mixed oil was subjected to a random interesterification reaction, and then subjected to hydrogenation until the iodine value reached 2 or less, thereby to obtain fats and oils A2 (iodine value: less than 1, lauric acid content: 20.3 mass %, palmitic acid content: 33.5 mass %, stearic acid content: 34.9 mass %).

The interesterification reaction was carried out in the same manner as in fats and oils A1.

The hydrogenation reaction was performed using a nickel catalyst at 160 to 200° C. until the iodine value reached 2 or less. After completion of the hydrogenation reaction, the nickel catalyst was removed by filtration, and decoloring and deodorization were performed to obtain a fully hydrogenated oil.

### [Fats and Oils C1]

A fully hydrogenated oil (lauric acid content: 45.7 mass %, slip melting point: 39.1° C.) of palm kernel was used as fats and oils C1.

### [Fats and Oils C2]

A fully hydrogenated oil of palm kernel stearin (lauric acid content: 53.9 mass %, slip melting point: 35.6° C.) was used as fats and oils C2.

### [Production of Fats and Oils Composition]

A fats and oils composition was produced by mixing the melted fats and oils in the formulation shown in Tables 1 to 2.

The fatty acid content and the triglyceride content of the obtained fats and oils composition were measured according to the above-described analysis methods. The measurement results are shown in Tables 1 to 2. The unit of the formulation and the content of the fats and oils composition is mass % (no unit for the mass ratio), and the unit of the SFC of the fats and oils composition is %.

TABLE 1

| | | Exam- | Exam- | Exam- | Exam- |
|---|---|---|---|---|---|
| | | ple 1 | ple 2 | ple 3 | ple 4 |
| Formulation of | Fats and oils A1 | 90 | 80 | 80 | 70 |
| fats and oils | Fats and oils B1 | 0 | 20 | 0 | 30 |
| composition | Fats and oils C1 | 10 | 0 | 0 | 0 |
| | Fats and oils C2 | 0 | 0 | 20 | 0 |
| Content and | C14 or less SFA | 38.7 | 34.4 | 44.5 | 33.9 |
| mass ratio in | C16 to 18 SFA | 42.5 | 48.8 | 38.8 | 51.3 |
| fats and oils | USFA | 18.3 | 16.4 | 16.3 | 14.3 |
| composition | SFA/USFA | 4.45 | 5.12 | 5.12 | 5.97 |
| | C40 to 48 TG | 60.1 | 62.6 | 56.9 | 62.5 |
| | P/St | 1.99 | 1.75 | 2.07 | 1.58 |
| | C10 or less SFA | 3.4 | 3.0 | 3.5 | 3.0 |
| | La/St | 1.82 | 1.30 | 2.35 | 1.14 |
| | C20 to 22 SFA | 0.3 | 0.4 | 0.3 | 0.4 |
| | TFA | 0.1 | 0.1 | 0.1 | 0.1 |
| | C34 to 38 TG | 15.6 | 12.0 | 21.7 | 11.8 |
| | C58 or more TG | 0.0 | 0.0 | 0.0 | 0,0 |
| SFC | 10° C. | 71.8 | 76.6 | 75.6 | 78.6 |
| | 20° C. | 54.9 | 62.8 | 58.9 | 67.4 |
| | 30° C. | 28.6 | 40.5 | 28.6 | 46.8 |

TABLE 2

| | | Exam- | Comparative | Comparative |
|---|---|---|---|---|
| | | ple 5 | Example 1 | Example 2 |
| Formulation of | Fats and oils A1 | 95 | 60 | 100 |
| fats and oils | Fats and oils B1 | 5 | 40 | 0 |
| composition | Fats and oils C1 | 0 | 0 | 0 |
| | Fats and oils C2 | 0 | 0 | 0 |
| Content and | C14 or less SFA | 35.1 | 33.4 | 35.3 |
| mass ratio in | C16 to 18 SFA | 45.1 | 53.7 | 43.9 |
| fats and oils | USFA | 19.4 | 12.3 | 20.4 |
| composition | SFA/USFA | 4.16 | 7.10 | 3.91 |
| | C40 to 48 TG | 62.7 | 62.4 | 62.8 |
| | P/St | 2.11 | 1.44 | 2.27 |
| | C10 or less SFA | 2.9 | 3.0 | 2.9 |
| | La/St | 1.62 | 1.01 | 1.76 |
| | C20 to 22 SFA | 0.4 | 0.4 | 0.4 |
| | TFA | 0.1 | 0.1 | 0.1 |
| | C34 to 38 TG | 12.2 | 11.6 | 12.3 |
| | C58 or more TG | 0.0 | 0.0 | 0.0 |
| SFC | 10° C. | 71.5 | 81.3 | 69.8 |
| | 20° C. | 55.4 | 71.7 | 52.4 |
| | 30° C. | 31.2 | 52.6 | 28 |

### [Production of Chocolate]

Using the fats and oils compositions of Examples 1 to 5 and the fats and oils compositions of Comparative Examples 1 and 2 chocolates of formulation 1 shown in Table 3 were produced by an ordinary method of manufacturing chocolate (mixing, refining, conching, cooling) without performing tempering and seeding (the unit of the formulation and the content is mass %). In addition, chocolate of formulation 2 shown in Table 3 was produced using the fats and oils composition of Example 2 by an ordinary method of manufacturing chocolate (mixing, refining, conching, cooling) without performing tempering and seeding (the unit of the formulation and the content is mass %). All the obtained chocolates had a moisture content of 3 mass % or less.

TABLE 3

| | | Formu- | Formu- |
|---|---|---|---|
| | | lation 1 | lation 2 |
| Chocolate | Fats and oils composition | 36 | 33 |
| formulation | Cocoa butter | 1.02 | 1.02 |
| | Cacao mass | 2.03 | 2.03 |
| | Cocoa powder | 16.95 | 16.95 |
| | Powder sugar | 43.45 | 29.45 |
| | Whole milk powder | 0 | 12 |
| | Skimmed milk powder | 0 | 5 |
| | Lecithin | 0.5 | 0.5 |
| | Flavor | 0.05 | 0.05 |
| | Total | 100.0 | 100.0 |
| Content in | Fats and oils | 40.0 | 40.0 |
| chocolate | Cocoa butter | 4.0 | 4.0 |
| | Cacao component | 19.0 | 19.0 |
| | Saccharinity | 43.5 | 29.5 |
| | Powdered milk | 0.0 | 17.0 |
| Content in fats | Fats and oils composition | 90.0 | 82.5 |
| and oils | Cocoa butter | 10.0 | 10.0 |

### [Evaluation of Melting Mouthfeel]

Four expert panels ate chocolate molded in a 5 g mold, and the chocolate was scored according to the following evaluation criteria. The average score of the four expert panels was calculated and evaluated according to the following evaluation criteria. As the evaluation result, it was determined that the chocolate had good melting mouthfeel when the average score was evaluated as Excellent, Good, or Fair. It should be noted that the expert panels who evaluated melting mouthfeel of chocolate have regularly received training of sensory evaluation such as melting mouthfeel of chocolate, and there are few individual differences in sensory evaluation results such as melting mouthfeel of chocolate.
3 points: Sharp melting mouthfeel with a sense of unity and good flavor release are felt.
2 points: Melting mouthfeel with a sense of unity and good flavor release are felt.
1 point: Overall melting mouthfeel tends to be slow, but flavor release is felt.
0 point: Melting mouthfeel is very slow from the top, and flavor release is also poor.

### <Average Score>

Excellent: 2.5 points or more
Good: 2.0 points or more and less than 2.5 points
Fair: 15 points or more and less than 2.0 points
Poor: less than 1.5 points

### [Evaluation of Solidification Properties]

Sixteen grams of chocolate adjusted to a temperature of 45° C. was filled in a petri dish having a diameter of 9 cm and uniformly dispersed in the petri dish, and then solidification of the chocolate was observed over time in a room adjusted to a temperature of 20° C. In the evaluation of the solidification properties of chocolate, the solidification start time and the solidification end time were measured, and comprehensive evaluation was performed according to the following evaluation criteria. The solidification start time was a time when chocolate started to form peaks when the chocolate was touched with fingers, and the solidification end time was a time when the chocolate surface was not gouged when the chocolate was touched with fingers. As the evaluation result of the comprehensive evaluation, it was determined that the chocolate had good solidification properties when the evaluation was Excellent, Good, or Fair.

### <Evaluation Criteria for Comprehensive Evaluation>

Excellent: Solidification ends within 4 minutes and 0 second.
Good: Solidification starts within 4 minutes and 0 second, and solidification ends within 5 minutes and 0 second.
Fair: Solidification starts within 4 minutes and 30 seconds, and solidification ends within 5 minutes and 30 seconds.
Poor: Solidification starts after 4 minutes and 30 seconds.

### [Evaluation of Blooming]

Chocolate molded in a 5 g mold was stored at 20° C. for 1 month, and the presence or absence of blooming was visually observed. As the evaluation result, the chocolate was evaluated as Good when no blooming occurred, and as Poor when blooming occurred.

TABLE 4

| | | | Example 6 | Example 7 | Example 8 | Example 9 |
|---|---|---|---|---|---|---|
| Used fats and oils composition | | | Example 1 | Example 2 | Example 3 | Example 4 |
| Formulation of chocolate | | | Formulation 1 | Formulation 1 | Formulation 1 | Formulation 1 |
| Evaluation | Melting mouthfeel | | Good | Good | Excellent | Fair |
| result | Solidification | Start time | 3 min and 50 sec | 2 min and 50 sec | 4 min and 10 sec | 2 min and 40 sec |
| | properties | End time | 5 min and 00 sec | 4 min and 00 sec | 5 min and 10 sec | 3 min and 30 sec |
| | | Comprehensive | Good | Excellent | Fair | Excellent |
| | | evaluation | | | | |

| | | | | |
|---|---|---|---|---|
| Blooming | Good | Good | Good | Good |

TABLE 5

| | | | | | Comparative | Comparative |
|---|---|---|---|---|---|---|
| | | | Example 10 | Example 11 | Example 3 | Example 4 |
| Used fats and oils composition | | | Example 5 | Example 2 | Comparative | Comparative |
| | | | | | Example 1 | Example 2 |
| Formulation of chocolate | | | Formulation 1 | Formulation 2 | Formulation 1 | Formulation 1 |
| Evaluation | Melting mouthfeel | | Good | Good | Poor | Good |
| result | Solidification | Start time | 4 min and 00 sec | 3 min and 10 sec | 2 min and 30 sec | 4 min and 50 sec |
| | properties | End time | 4 min and 50 sec | 4 min and 10 sec | 3 min and 20 sec | 5 min and 30 sec |
| | | Comprehensive | Good | Good | Excellent | Poor |
| | | evaluation | | | | |

| | | | | |
|---|---|---|---|---|
| Blooming | Good | Good | Good | Good |

As can be seen from Tables 4 and 5, the chocolate of Examples had good solidification properties and melting mouthfeel and hardly caused blooming.

On the other hand, as can be seen from Table 5, the chocolate of Comparative Example 3 had poor melting mouthfeel. The chocolate of Comparative Example 4 was not satisfactory in solidification properties.

1. A fats and oils composition for chocolate satisfying conditions (a) to (e) below:
(a) 25 to 55 mass % of a saturated fatty acid having 14 or less carbons is contained as a constituent fatty acid;
(b) 30 to 60 mass % of a saturated fatty acid having 16 to 18 carbons is contained as a constituent fatty acid;
(c) 5 to 30 mass % of an unsaturated fatty acid is contained as a constituent fatty acid;
(d) a mass ratio of a content of a saturated fatty acid to a content of an unsaturated fatty acid in constituent fatty acids is 4.0 to 7.0; and
(e) 50 to 75 mass % of a triglyceride in which a total number of carbons of constituent fatty acid residues is 40 to 48 is contained.

2. The fats and oils composition for chocolate according to claim 1, which satisfies condition (f) below:
(f) a mass ratio of a content of palmitic acid to a content of stearic acid in constituent fatty acids is 1.5 to 2.2.

3. Chocolate comprising the fats and oils composition for chocolate according to claim 1.

4. The chocolate according to claim 3, wherein 70 mass % or more of the fats and oils composition for chocolate is contained in fats and oils contained in the chocolate.

5. Chocolate comprising the fats and oils composition for chocolate according to claim 2.

6. The chocolate according to claim 5, wherein 70 mass % or more of the fats and oils composition for chocolate is contained in fats and oils contained in the chocolate.
